(19) United States
(12) Patent Application Publication
(10) Pub. No.: US 2017/0276918 A1
(43) Pub. Date: Sep. 28, 2017

(54) ULTRA-COMPACT HEAD-UP DISPLAYS BASED ON FREEFORM WAVEGUIDE

(71) Applicant: Arizona Board of Regents of Behalf of the University of Arizona, Tucson, AZ (US)

(72) Inventor: Hong Hua, Tucson, AZ (US)

(21) Appl. No.: 15/506,376

(22) PCT Filed: Aug. 27, 2015
(86) PCT No.: PCT/US15/47163

§ 371 Date: Feb. 24, 2017

Related U.S. Application Data
(60) Provisional application No. 62/043,770, filed on Aug. 29, 2014.

(51) Int. Cl. G02B 17/08; G02B 27/01

(52) U.S. Cl. CPC G02B 17/08; G02B 27/0172; G02B 2027/0118; G02B 2027/015

(57) ABSTRACT

Ultra-compact head-up displays with freeform waveguides are provided.

### FIELD OF THE INVENTION

The present invention relates generally to ultra-compact head-up displays, and more particularly to ultra-compact head-up displays having a freeform waveguide.

### BACKGROUND OF THE INVENTION

It is highly desirable in developing a head-up display (HUD) with a waveguide-like ultra-compact form factor to maintain a large field of view (FOV), a large, uniform eye box, a long eye relief, and high image brightness. Such a display has a wide range of applications in aviation, automobile, and military fields.

The fundamental challenge in achieving a compact HUD system lies in the desire for a waveguide-like compact form factor. Although several optical approaches have been explored in designing waveguide-like head-mounted displays to some great extent (for instance, Lumus light guide approach, holographic waveguide approach, freeform wedge prisms and waveguide), it is extremely challenging to adapt such technologies to a HUD system due to the dramatically increased eye-box size and eye relief requirements.

### SUMMARY OF THE INVENTION

In one of its aspects, the present invention relates to optical methods of achieving an ultra-compact HUD design with waveguide-like form factor using freeform optical technology.

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates a waveguide device composed of multiple freeform surfaces;

FIG. 2 schematically illustrates an optical layout of a HUD system based on a wedge-shaped freeform prism composed of multiple freeform surfaces;

FIG. 3 schematically illustrates an optical layout of waveguide-based HUD using a dual-channel freeform waveguide;

FIG. 4 schematically illustrates a waveguide-based HUD using a four-channel freeform waveguide;

FIG. 5 schematically illustrates an optical layout of a waveguide-based HUD using a segmented freeform waveguide; and

FIG. 6 schematically illustrates an optical layout of a HUD system using a freeform waveguide composed of an array of miniature reflectors.

### DETAILED DESCRIPTION OF THE INVENTION

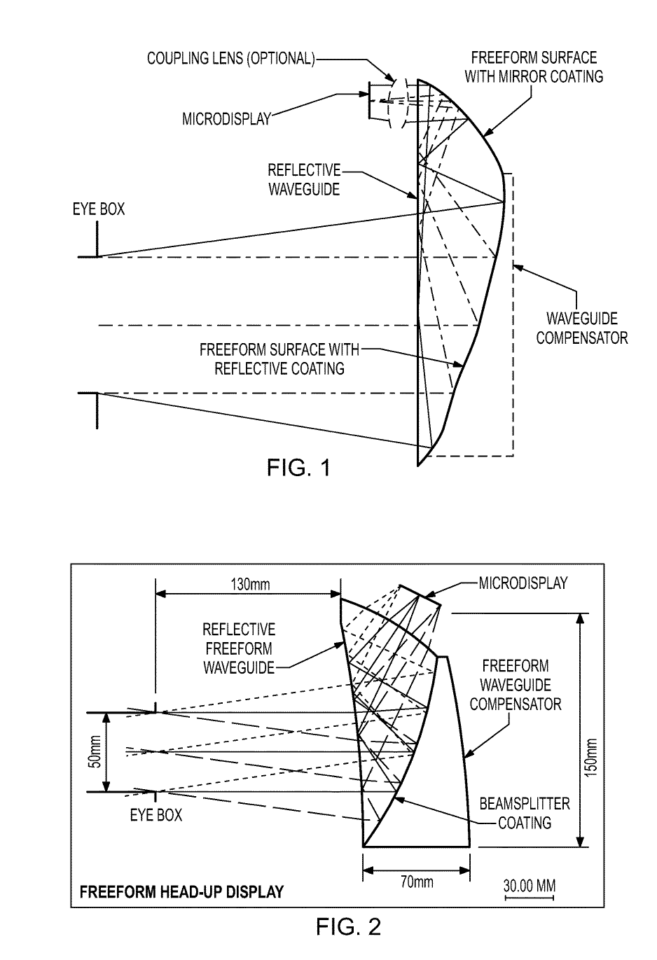

Referring now to the figures, wherein like elements are numbered alike throughout, FIG. 1 shows a schematic diagram of an exemplary waveguide based on freeform optical surfaces. In this scheme, light from a microdisplay is propagated via multiple internal reflections through a waveguide element formed by multiple freeform optical surfaces. The device may be composed of two main elements: a freeform reflective waveguide and a freeform waveguide compensator. The freeform reflective waveguide may be a plastic, wedge-shaped, prism-like solid formed by multiple freeform optical surfaces. Light from a microdisplay may be coupled into the waveguide directly or optionally by a coupling lens, and may be propagated through the waveguide via multiple internal reflections by the internally reflective surfaces and eventually coupled into a viewer's eye through reflection/refraction. As a result, the reflective waveguide may serve not only the functions of light collimation and projection, but also waveguide propagation. Due to the wedge shape and freeform surfaces, a freeform waveguide compensator cemented with the freeform reflective waveguide may be required to correct distortions introduced into the direct view of the outside world, in order to maintain an intact see-through view.

Unlike a head-mounted or head-worn display (HMD), in a HUD system the eyebox and eye relief requirements are several times larger than those parameters for an HMD system to ensure proper viewing, since the display is not head-worn or affixed with the user. For instance, in a typical HMD system, the eyebox is about 10 mm and the eye clearance is about 20 mm, while in a HUD system, the typical eyebox is about 50 mm or larger, and the eye clearance is about 100 mm or greater. These unique requirements in a HUD system not only impose great challenges in designing a waveguide, but also set apart a HUD system from a head-mounted display system.

FIG. 2 illustrates an exemplary configuration of a HUD system design using a freeform wedge-shaped prism. The wedge shaped freeform prism may include three optical surfaces. Light rays from a microdisplay propagate through the prism through consecutive refraction, reflections, and refraction by these surfaces and enter a viewer's eye which is placed inside of the eyebox. In addition to the main prism, the optics may also include a freeform waveguide compensator which is cemented to the back surface of the prism in order to correct distortions introduced by the prism to the see-through view of the real-world scene. The compensator may include two optical surfaces, one of which may have an identical prescription to the back surface of the prism to which it may be cemented. The back surface of the freeform waveguide may be coated with a beamsplitter coating to enable both display and see-through views. The overall specifications of the system are summarized in Table 1. The main objective is to achieve a very compact, lightweight, and wide field of view HUD viewing system. In this exemplary configuration, a high resolution microdisplay (approximately 2-inch diagonal) was used as an image source, with a pixel resolution of 1600 by 1200 in horizontal and vertical directions, respectively. The full field of view of the system is 24 degrees by 16 degrees in the horizontal and vertical directions, respectively. The equivalent focal length of the viewing optics is 100 mm. The system was designed to achieve a 50 mm exit pupil diameter with a 130 mm eye clearance from the prism. This configuration leads to a system with an f/number of 2.0. Due to the large box and long eye clearance, the design resulted in a reflective freeform waveguide of about 70 mm thickness and 100 mm width and 150 mm height.

TABLE 1
First-order optical specifications of the optical design in FIG. 2.

| Parameter | Specification |
|---|---|
| Microdisplay | |
| Active display area | 42.6 mm (H) × 28 mm (V) or 51 mm (D) |
| Number of microdisplay | 1 |
| HUD display system | |
| Field of view | 24° (H) × 16° (V) or 28.6° (D) |
| Effective focal length | 100 mm |
| Exit pupil diameter | 50 mm |
| Eye clearance | 130 mm |
| F/# | 2.0 |
| Number of optical surfaces | 3 |
| See-through viewing system | |
| Optics | Wedge-shaped prism + freeform |
| | compensator lens |
| Number of optical surfaces | 4 |
| Other parameters | |
| Wavelength | 656.3-486.1 nm |
| Material | Acrylic (optical plastics) |

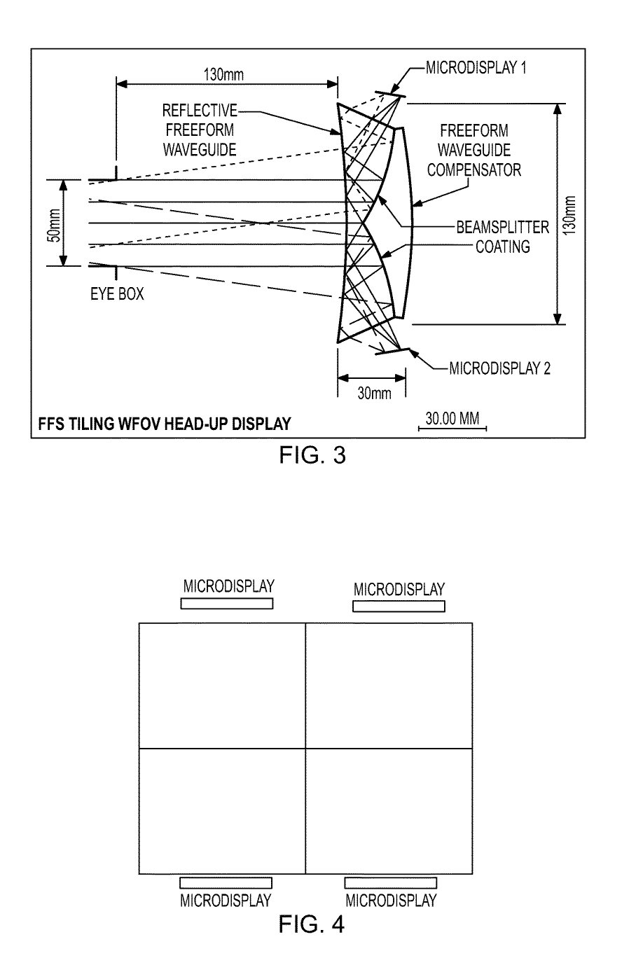

The main drawback of the design embodiment in FIG. 2 lies in the thickness and large size of the waveguide. FIG. 3 illustrates an alternative implementation that dramatically reduces the size and thickness of the waveguide element while achieving the same performance goals. In this exemplary configuration, a two-channel freeform waveguide was designed to replace the single prism-shape waveguide in FIG. 2, which allowed achieving the same FOV and eyebox size while substantially reducing the thickness of the waveguide.

Two microdisplays are utilized in this dual-channel design, each of which serves as an image source for the corresponding optics channel. Each of the microdisplays is approximately 1 inch diagonally, half of the size of the microdisplay used in the design in FIG. 2. Each optics channel includes three optical surfaces with a similar configuration to that of the design in FIG. 2. As shown in FIG. 3, the microdisplay 1 and the upper channel of the optics creates the top half field of view of the HUD system, while the microdisplay 2 and lower channel of the optics creates the bottom half of the field of view. The entire field of view is accessible through the entire 50 mm eyebox. It is worth pointing out that the two optics channels may share the same front optical surface (i.e., surface closest to the eyebox) as in this implementation or may have a different prescription for each channel. Besides the two-channel freeform waveguide, a freeform waveguide compensator may be provided to correct the distortions induced by the prism-like waveguide to the see-through view of the real-world scene. The compensator may include three surfaces, two of which are cemented with the back surfaces of the waveguide in which the two cemented surfaces may be coated with a beamsplitter coating. By utilizing two optics channels, the overall thickness of the waveguide with compensator is reduced down to 30 mm. In the embodiment demonstrated in FIG. 3, two optics channels were used. More channels can be potentially implemented using similar tiling schemes. FIG. 4 illustrates a schematic layout with a total of 4 optics channels, which is anticipated to further reduce the thickness of the waveguide.

The overall specifications of the embodiment of FIG. 3 are summarized in Table 2. Here, two high resolution microdisplays are used as image sources. The full field of view of the system is 24 degrees by 16 degrees in horizontal and vertical directions, respectively. The equivalent focal length of the viewing optics is 70 mm. The system is designed to achieve a 50 mm exit pupil diameter with a 130 mm eye clearance from the waveguide. This configuration leads to a system with an f/number of 1.4. The dual-channel design results in a freeform waveguide of about 30 mm thickness and 100 mm width and 130 mm height. The design in FIG. 3 requires two different optics channels, so one downside to this approach is the need for multiple microdisplays.

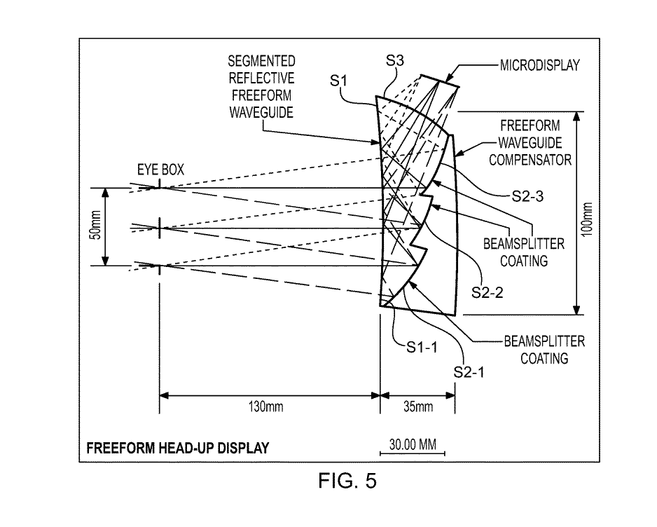

FIG. 5 shows the optical layout of a different approach to a HUD display system. In this implementation, the back freeform surface of FIG. 2 is divided into multiple segments (e.g., 3 segments in this exemplary configuration). Each segment images a sub-region of the single microdisplay and covers a sub-region of the exit pupil diameter, and the multiple segments together form a continuous image for a continuous large eye box. Due to the segmented nature of the freeform surface, each of the segments can be positioned much closer to the front surface and consequently the overall thickness of the waveguide can be significantly reduced.

TABLE 2
First-order optical specifications of the optical design in FIG. 3.

| Parameter | Specification |
|---|---|
| Microdisplay | |
| Active display area | 29.6 mm (H) × 20 mm (V) |
| Number of microdisplays | 2 |
| HUD display system | |
| Field of view | 24° (H) × 16° (V) or 28.6° (D) |
| Effective focal length | 70 mm |
| Exit pupil diameter | 50 mm |
| Eye clearance | 130 mm |
| F/# | 1.4 |
| Number of optical surfaces | 5 |
| Number of optics channels | 2 |
| See-through viewing system | |
| Optics | Dual-channel prism + freeform |
| | compensator lens |
| Number of optical surfaces | 6 |
| Other parameters | |
| Wavelength | 656.3-486.1 nm |
| Material | Acrylic (optical plastics) |

The overall specifications of the system are summarized in Table 3. Different from the design in FIG. 3, the embodiment in FIG. 5 only uses one microdisplay (approximately 2-inch diagonal) as the image source. As shown in FIG. 5, each of the freeform segments may have a different surface tilt, decenter, and surface shape. Each segment of the freeform waveguide individually creates only a small field of view, and multiple segments together create a full field of view of 24 degrees by 16 degrees in horizontal and vertical directions, respectively. The equivalent focal length of the viewing optics is 100 mm. The overall system achieves a 50 mm exit pupil diameter and a 130 mm eye clearance. With the 3-segment freeform waveguide implementation of FIG. 5, the design results in a segmented freeform waveguide of about 35 mm thickness. Besides the segmented freeform waveguide, a segmented freeform compensator is designed to correct the distortions induced by the prism-like waveguide to the see-through view of the real-world scene. The compensator may include four surfaces, three of which form a segmented freeform surface and are cemented with the back segmented surfaces of the waveguide, in which the cemented surfaces may be coated with a beamsplitter coating. Though 3 segments were demonstrated in this embodiment, fewer or more segments can be utilized. Using additional segments is expected to achieve a thinner waveguide at the cost of a higher fabrication challenge and higher risk of stray light.

TABLE 3
First-order optical specifications of the optical design in FIG. 5.

| Parameter | Specification |
|---|---|
| Microdisplay | |
| Active display area | 42.6 mm (H) × 28 mm (V) |
| Number of microdisplays | 1 |
| HUD display system | |
| Field of view | 24° (H) × 16° (V) or 28.6° (D) |
| Effective focal length | 100 mm |
| Exit pupil diameter | 50 mm |
| Eye clearance | 130 mm |
| F/# | 2.0 |
| Number of optical surfaces | 5 |
| Number of optics channels | 3 |
| See-through viewing system | |
| Optics | Segmented freeform prism + |
| | segmented freeform compensator |
| | lens |
| Number of optical surfaces | 8 |
| Other parameters | |
| Wavelength | 656.3-486.1 nm |
| Material | Acrylic (optical plastics) |

In Table 4, the system prescriptions for the exemplary design layout shown in FIG. 5 are listed. In this implementation, Surface 1 and Surface 1-1 represent the same physical surface which has been used twice in the optical path, once in refraction mode and once in reflection mode. Surface 2 is composed of three segments, S2-1, S2-2, and S2-3, respectively.

TABLE 4
System prescription of an embodiment for the optical design in FIG. 5.

| Element | | | | | |
|---|---|---|---|---|---|
| number used in | Surface | | | | Refract |
| figures | Type | Y Radius | Thickness | Material | Mode |
| Eye box | Sphere | Infinity | 0.000 | | Refract |
| S1 | XY Poly | −998.5 | 0.000 | PMMA | Refract |
| S2-1 | XY Poly | −242.3 | 0.000 | PMMA | Reflect |
| S2-2 | XY Poly | −219.7 | 0.000 | PMMA | Reflect |
| S2-3 | XY Poly | −210.2 | 0.000 | PMMA | Reflect |
| S1-1 | XY Poly | −998.5 | 0.000 | PMMA | Reflect |
| S3 | Sphere | Infinity | 0.000 | PMMA | Refract |

One or more of the surfaces in the design layout shown in FIG. 5 may utilize a type of freeform surface. In the embodiment example shown in Table 4, all of the surfaces were embodied as an “XY Poly” type. The term “XY Poly” refers to a surface which may be represented by the equation

$$z = \frac{{cr}^{2}}{1 + \sqrt{1 - ( 1 + k ) {c}^{2} {r}^{2}}} + {\sum }_{j = 2}^{66} {C}_{j} {x}^{m} {y}^{n}$$

$$j = \frac{{( m + n )}^{2} + m + 3 m}{2} + 1 ,$$

where z is the sag of the free-form surface measured along the z-axis of a local x, y, z coordinate system, c is the vertex curvature (CUY), r is the radial distance, k is the conic constant, and Cⱼ is the coefficient for x^{m}yⁿ. The optical prescriptions for these surfaces (S1-1 through S3) are listed in Table 5, while the surface decenters with respect to the global origin which coincides with the center of the eye box are listed in Table 6.

TABLE 5
Optical surface prescriptions of the optical system of Table 4.

| | S1-1 & S1-2 | S2-1 | S2-2 | S2-3 | S3 |
|---|---|---|---|---|---|
| Y Radius | −998.5 | −242.3 | −219.7 | −210.2 | −130.126 |
| k | 0.95 | −0.565 | −0.358 | −0.67 | −8.5 |
| X**2 | −1.8e−5 | −1.2e−5 | −1.2e−5 | −1.2e−5 | 0 |
| Y**2 | 7.2e−6 | 4.51e−6 | 4.51e−6 | 4.51e−6 | 0 |
| X**2 * Y | −1.2e−4 | −1.55e−6 | −1.55e−6 | −1.55e−6 | 0 |

TABLE 6
Optical surface positions and orientations of the optical system
of Table 4 with respect to the center of the eye box.

| | Origin of surface reference | | | Orientation of the surface |
|---|---|---|---|---|
| | X (mm) | Y (mm) | Z (mm) | Rotation about X-axis θ (°) |
| S1 | 0 | 0 | 130 | 0 |
| S2-1 | 0 | −15 | 150 | −30.8 |
| S2-2 | 0 | 0 | 148 | −29.2 |
| S2-3 | 0 | 10 | 145 | −27.7 |
| S3 | 0 | 70 | 152 | 57.4 |

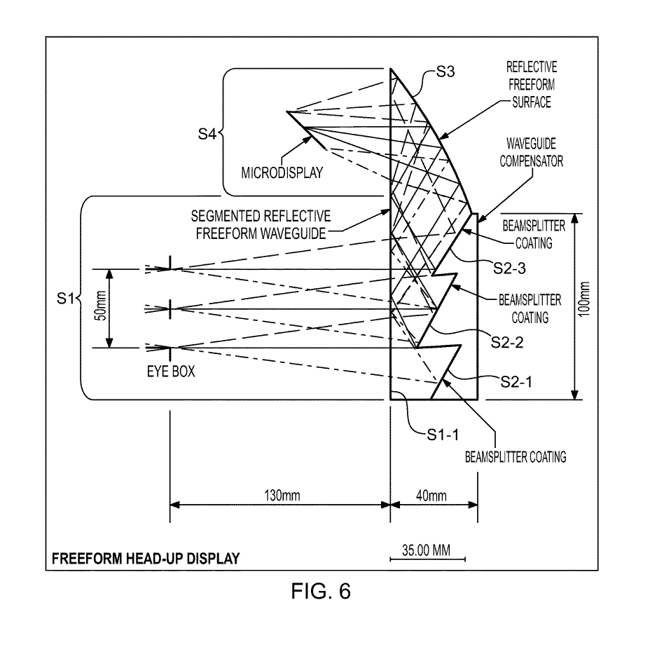

Through the use of a multi-segment freeform waveguide, the design in FIG. 5 can effectively reduce the thickness of the waveguide. However, fabricating a multi-segment freeform waveguide imposes greater challenges than a single-segment waveguide like the one shown in FIG. 2. Particularly, each of the freeform segments may have not only a different surface tilt and decenter, but also a different surface shape. In order to mitigate this potential challenge and reduce fabrication cost, FIG. 6 demonstrates an alternative embodiment. In this embodiment, instead of utilizing a segmented freeform surface, the segmented surface is formed by planar surfaces each of which is placed at the same orientation with respect to the front surface but at different positions. In order to design such a waveguide with significant optical power required for the HUD system, an additional internally reflective freeform surface may be added which contributes most of the optical power for collimating the light rays. The segmented plane surfaces may be coated with a beamsplitting coating in order to enable a see-through field of view. The waveguide compensator, which is cemented with the main waveguide may be composed of a segmented flat surface matching the surface on the main waveguide. Such simplification of the segmented freeform surface to a segmented planar surface is expected to be much easier to fabricate and assemble at substantially reduced cost.

The overall specifications of the system are summarized in Table 7. Similar to the design shown in FIG. 5, the embodiment in FIG. 6 only utilizes one microdisplay (approximately 2-inch diagonal) as the image source. Each segment of the segmented internally reflective surface has the same surface tilt and surface shape. Similar to the design in FIG. 5, each segment of the waveguide only creates a small field of view, and the multiple segments together create a full field of view of 24 degrees by 16 degrees in the horizontal and vertical directions, respectively. The equivalent focal length of the viewing optics is 100 mm. Most or even all of the optical power may be contributed by the reflective freeform surface. The overall system can achieve a 50 mm exit pupil diameter and a 130 mm eye clearance. With a 3-reflector (3-segment) array, the design results in a segmented freeform waveguide of about 40 mm thickness. Though 3 segments are demonstrated in this embodiment, fewer or more segments can be utilized. Using additional segments is expected to achieve a thinner waveguide at the cost of higher fabrication challenge and higher risk of stray light.

TABLE 7
First-order optical specifications of the optical design in FIG. 6.

| Parameter | Specification |
|---|---|
| Microdisplay | |
| Active display area | 42.6 mm (H) × 28 mm (V) |
| Number of microdisplays | 1 |
| HUD display system | |
| Field of view | 24° (H) × 16° (V) or 28.6° (D) |
| Effective focal length | 100 mm |
| Exit pupil diameter | 50 mm |
| Eye clearance | 130 mm |
| F/# | 2.0 |
| Number of optical surfaces | 5 |
| Number of optics channels | 3 |
| See-through viewing system | |
| Optics | Segmented freeform waveguide + |
| | segmented compensator lens |
| Number of optical surfaces | 8 |
| Other parameters | |
| Wavelength | 656.3-486.1 nm |
| Material | Acrylic (optical plastics) |

In Table 8, the system prescriptions for an embodiment of the design layout in FIG. 6 are listed. In this implementation, Surface 1 and Surface 1-1 represent the same physical surface which has been used twice in the optical path, once in refraction mode and once in reflection mode. Surface 2 is composed of three segments, S2-1, S2-2, and S2-3, respectively.

TABLE 8
System prescription of an embodiment for the optical design in FIG. 6.

| Element | | | | | |
|---|---|---|---|---|---|
| number used in | | | | | Refract |
| figures | Surface Type | Y Radius | Thickness | Material | Mode |
| Stop | sphere | Infinity | 0.000 | | Refract |
| S1 | sphere | Infinity | 0.000 | PMMA | Refract |
| S2-1 | sphere | Infinity | 0.000 | PMMA | Reflect |
| S2-2 | sphere | Infinity | 0.000 | PMMA | Reflect |
| S2-3 | sphere | Infinity | 0.000 | PMMA | Reflect |
| S1-1 | sphere | Infinity | 0.000 | PMMA | Reflect |
| S3 | XY Poly | −249.5 | 0.000 | PMMA | Reflect |
| S4 | XY Poly | −545 | 0 | PMMA | Refract |

One or both of the surfaces S3 or S4 in the design layout shown in FIG. 6 may utilize a type of freeform surfaces. In the embodiment example shown in Table 8, both of the surfaces S3 and S4 were embodied as an “XY Poly” type. The optical prescriptions for these surfaces (S3 and S4) are listed in Table 9. The surface decenters for all of the surfaces (S1 through S4) with respect to the global origin which coincides with the center of the eye box are listed in Table 10.

TABLE 9
Optical surface prescription of the optical system of Table 8.

| | S3 | S4 |
|---|---|---|
| Y Radius | −249.5 | −545 |
| Conic | 1.2 | −2.34 |
| Constant | | |
| X**2 | −1.13e5 | −2.44e−50 |
| Y**2 | 3.8e−5 | 1.85e−6 |
| X**2 * Y | −6.5e−6 | −8.76e−6 |

TABLE 10
Optical surface position and orientations of the optical system
of Table 8 with respect to the center of the eye box.

| | Orientation of the surface | | | Origin of surface reference |
|---|---|---|---|---|
| | X (mm) | Y (mm) | Z (mm) | Rotation about X-axis θ (°) |
| Surface 1 | 0 | 0 | 130 | 0 |
| Surface 2-1 | 0 | −25 | 170 | −30 |
| Surface 2-2 | 0 | 0 | 155 | −30 |
| Surface 2-3 | 0 | 28 | 158 | −30 |
| Surface 3 | 0 | 75 | 170 | 22 |
| Surface 4 | 0 | 105 | 130 | 0 |

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A segmented freeform waveguide, comprising:
first and second elongated optical surfaces each having respective first and second ends, the first ends thereof joined to one another at a first end of the waveguide and the second ends thereof disposed in spaced apart relation, the second optical surface comprising at least two surface segments, the segments comprising a step height change therebetween; and
a third optical surface disposed between the second ends of the first and second elongated optical surfaces, at least one of the first, second, and third optical surfaces having optical power.

2. The segmented freeform waveguide according to claim 1, wherein the first optical surface comprises a freeform surface.

3. The segmented freeform waveguide according to claim 1, wherein the first optical surface comprises a flat surface.

4. The segmented freeform waveguide according to claim 1, wherein the first optical surface comprises a spherical surface.

5. The segmented freeform waveguide according to claim 1, wherein the first optical surface has optical power.

6. The segmented freeform waveguide according to claim 1, wherein the first and second elongated optical surfaces and third optical surface are oriented relative to one another to define a wedge-shaped solid therebetween to provide a wedge-shaped, freeform waveguide.

7. The segmented freeform waveguide according to claim 1, wherein the third optical surface comprises a freeform surface.

8. The segmented freeform waveguide according to claim 1, wherein the third optical surface comprises a spherical surface.

9. The segmented freeform waveguide according to claim 1, wherein the at least two surface segments of the second optical surface each comprise a flat surface.

10. The segmented freeform waveguide according to claim 1, wherein the at least two surface segments of the second optical surface each comprise a spherical surface.

11. The segmented freeform waveguide according to claim 1, wherein the at least two surface segments of the second optical surface each comprise a freeform surface.

12. The segmented freeform waveguide according to claim 11, wherein the at least two surface segments have a different shape.

13. The segmented freeform waveguide according to claim 1, wherein the at least two surface segments of the second optical surface each comprise optical power.

14. A head-up display, comprising:
the segmented freeform waveguide according to claim 1; and
a microdisplay in optical communication with the segmented freeform waveguide.

15. The head-up display according to claim 14, wherein the microdisplay is positioned relative to the segmented freeform waveguide such that light emitted by the microdisplay is received by the segmented freeform waveguide through the third surface of the segmented freeform waveguide.

16. The head-up display according to claim 15, wherein the microdisplay is positioned relative to the segmented freeform waveguide such that light emitted by the microdisplay is received by the segmented freeform waveguide through the first surface of the segmented freeform waveguide.

17. The head-up display according to claim 16, wherein the light received from the micro display is internally reflected off of the third optical surface.

18. The head-up display according to claim 14, wherein the light received from the micro display is internally reflected off of the at least two surface segments of the segmented freeform waveguide.

19. The head-up display according to claim 14, wherein the light received from the micro display is totally internally reflected off of the at least two surface segments of the segmented freeform waveguide.
